(19) United States
(12) Patent Application Publication
(10) Pub. No.: US 2009/0023123 A1
(43) Pub. Date: Jan. 22, 2009

(54) AUDIO INPUT DEVICE AND KARAOKE APPARATUS TO DETECT USER'S MOTION AND POSITION, AND ACCOMPANIMENT METHOD ADOPTING THE SAME

(75) Inventor: Min-cheol SEO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/013,686

(22) Filed: Jan. 14, 2008

(30) Foreign Application Priority Data
Jul. 16, 2007 (KR) 2007-71340

(51) Int. Cl. G09B 5/00; G10H 1/36

(52) U.S. Cl. 434/307 A; 84/610

(57) ABSTRACT

An audio input device and a karaoke apparatus to detect user's motion and position, and an accompaniment method adopting the same. According to the audio input device and the karaoke apparatus, at least one of user's motion information and position information is detected and transmitted to the karaoke apparatus through a USB interface. Accordingly, the user can use diverse functions of the karaoke apparatus more conveniently.

### CROSS-REFERENCE TO RELATED APPLICATIONS

This application claims priority under 35 U.S.C. §119 from Korean Patent Application No. 10-2007-0071340, filed on Jul. 16, 2007, in the Korean Intellectual Property Office, the entire disclosure of which is incorporated herein by reference.

### BACKGROUND OF THE INVENTION

1. Field of the Invention

The present general inventive concept relates to an audio input device and a karaoke apparatus to detect user's motion and position, and an accompaniment method adopting the same. More particularly, the present general inventive concept relates to an audio input device and a karaoke apparatus to detect user's motion and position, and an accompaniment method adopting the same, which can transmit information using an interface.

2. Description of the Related Art

A karaoke has been widely known and used as an amusement device. Generally, the karaoke is provided with a microphone for inputting user's voice. The karaoke is also provided with a remote controller required for a selection of music, adjustment of a tone, adjustment of accompaniment speed, and the like.

Accordingly, a user should manipulate the microphone and the remote controller in a separate manner, and this may cause the user inconvenience. Particularly, in the case of adjusting a tone or an accompaniment speed while the user sings a song, the user should take the microphone off and then push a corresponding button of the remote controller.

On the other hand, with the popularization of karaoke, it is required for the karaoke to provide diverse functions in addition to the accompaniment. Thus, there is a need for a method for transmitting other information to the karaoke in addition to audio information from the microphone.

Accordingly, a scheme for enabling a user to conveniently use a karaoke through the use of a microphone having diverse functions has been demanded.

### SUMMARY OF THE INVENTION

The present general inventive concept provides an audio input device and a karaoke apparatus to detect user's motion and position information, and an accompaniment method adopting the same, which enables a user to conveniently use the karaoke apparatus through a microphone having diverse functions.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an audio input device, which may include an audio acquisition unit to receive an input of an audio from a user, a detection unit to detect at least one of user's motion information and position information, and an interface to transmit an audio signal inputted through the audio acquisition unit and the motion information and the position information detected by the detection unit to an external device.

The interface may include a Universal Serial Bus (USB) interface.

The detection unit may include at least one motion detection sensor or at least one position detection sensor.

The motion detection sensor may include a gyro sensor.

The position detection sensor may include a gyro sensor, and the detection unit may detect a present position by receiving an input of a position change from the gyro sensor after an initial position is set.

The audio input device may further include an input unit to receive control information from a user.

The foregoing and/or other aspects and utilities of the present general inventive concept may also be achieved by providing an accompaniment method, which comprises receiving an input of an audio from a user, detecting at least one of user's motion information and position information, and transmitting an input audio signal and the detected motion information and position information to an external device.

The transmitting operation may include transmitting the input signal and information through a Universal Serial Bus (USB) interface.

The foregoing and/or other aspects and utilities of the present general inventive concept may also be achieved by providing a karaoke apparatus, which may include an interface to receive at least one of an audio signal, motion information, and position information from a first external device, an audio processing/outputting unit to process and output the audio signal to a speaker so that sound is produced from the speaker, and a control unit to control an operation of a second external device using at least one of the motion information and the position information.

The interface may include a Universal Serial Bus (USB) interface.

The control unit may control an audio output so as to give a sound effect according to the motion information when the motion information is received through the interface.

The control unit may control an image capturing device connected to the karaoke so that an operation of the image capturing device is changed according to the position information if the position information is received through the interface.

The foregoing and/or other aspects and utilities of the present general inventive concept may also be achieved by providing an accompaniment method, which may include receiving at least one of an audio signal, motion information, and position information from a first external device, processing and outputting the audio signal to a speaker so that sound is produced from the speaker, and controlling an operation of a second external device using at least one of the motion information and the position information.

The receiving operation may include receiving the signal and information through a Universal Serial Bus (USB) interface.

The accompaniment method may further include controlling an audio output so as to give a sound effect according to the motion information when the motion information is received.

The accompaniment method may further include controlling an image capturing device so that an operation of the image capturing device is changed according to the position information if the position information is received.

The foregoing and/or other aspects and utilities of the present general inventive concept may also be achieved by providing an audio input device, which may include an input unit to receive an input of control information from a user; and an interface to transmit an audio signal and the input control information to an external device through serial communications.

The interface may include a Universal Serial Bus (USB) interface.

The foregoing and/or other aspects and utilities of the present general inventive concept may also be achieved by providing a karaoke apparatus, which may include an interface to receive at least one of an audio signal and control information from a first external device through serial communications, and a control unit to control an operation of a second external device using the control information.

The interface may include a Universal Serial Bus (USB) interface.

The foregoing and/or other aspects and utilities of the present general inventive concept may also be achieved by providing an audio input device including an audio acquisition unit to receive an input of an audio from a user, a detection unit to detect at least one of user's motion information and position information, an input unit to receive an input of control information from a user; and an interface to transmit an audio signal inputted through the audio acquisition unit, at least one of the motion information and the position information detected by the detection unit to an external device, and the input control information.

The foregoing and/or other aspects and utilities of the present general inventive concept may also be achieved by providing a karaoke apparatus including an interface to receive a combination of at least two of an audio signal, at least one of motion information and position information, and control information from an external device, an audio processing/outputting unit to process and output the audio signal to a speaker so that sound is produced from the speaker, and a control unit to control at least two devices according to the combination.

The foregoing and/or other aspects and utilities of the present general inventive concept may also be achieved by providing a karaoke system including an audio input device to receive an input of an audio from a user, to detect at least one of user's motion information and position information, to receive an input of control information from a user, and to transmit a combination of an audio signal inputted through the audio acquisition unit, at least one of the motion information and the position information detected by the detection unit to an external device, and the input control information, and a karaoke apparatus connectable to the audio input device to receive the combination, to control a speaker and another device according to the combination.

The foregoing and/or other aspects and utilities of the present general inventive concept may also be achieved by providing a karaoke system including an audio input device to transmit a combination of at least two of an input of a sound of a user, control information, and at least one of motion and position information, and a karaoke apparatus connectable to the audio input device to receive the combination from the audio input device, and to control at least two devices according to the received combination.

The foregoing and/or other aspects and utilities of the present general inventive concept may also be achieved by providing an audio input device including an audio acquisition unit to receive an input of an audio from a user, a unit to generate at least one of control information and one of motion information and position information, and an interface to output the audio input and the at least one of the control information and the motion information.

The foregoing and/or other aspects and utilities of the present general inventive concept may also be achieved by providing a karaoke apparatus including an interface to receive an audio input and at least one of control information and one of motion information and position information, and a control unit to control at least two devices according to the audio input and the at least one of the control information and the one of the motion information and position information.

The foregoing and/or other aspects and utilities of the present general inventive concept may also be achieved by providing a method of a karaoke system, the method including receiving an input of an audio from a user, detecting at least one of user's motion information and position information, receiving an input of control information from a user, and transmitting a combination of an audio signal inputted through the audio acquisition unit, at least one of the motion information and the position information detected by the detection unit to an external device, and the input control information; and receiving the transmitted combination, and controlling a speaker and another device according to the combination.

The foregoing and/or other aspects and utilities of the present general inventive concept may also be achieved by providing a method of a karaoke system, the method including transmitting a combination of at least two of an input of a sound of a user, control information, and at least one of motion and position information; and receiving the combination from the audio input device, and controlling at least two devices according to the received combination

### BRIEF DESCRIPTION OF THE DRAWINGS

These and/or other aspects and utilities of the present general inventive concept will become apparent and more readily appreciated from the following description of the

FIG. 1 is a block diagram illustrating a karaoke system according to an embodiment of the present general inventive concept;

FIG. 2 is a flowchart illustrating an accompaniment method of a microphone according to an embodiment of the present general inventive concept; and

FIG. 3 is a flowchart illustrating an accompaniment method of a karaoke apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

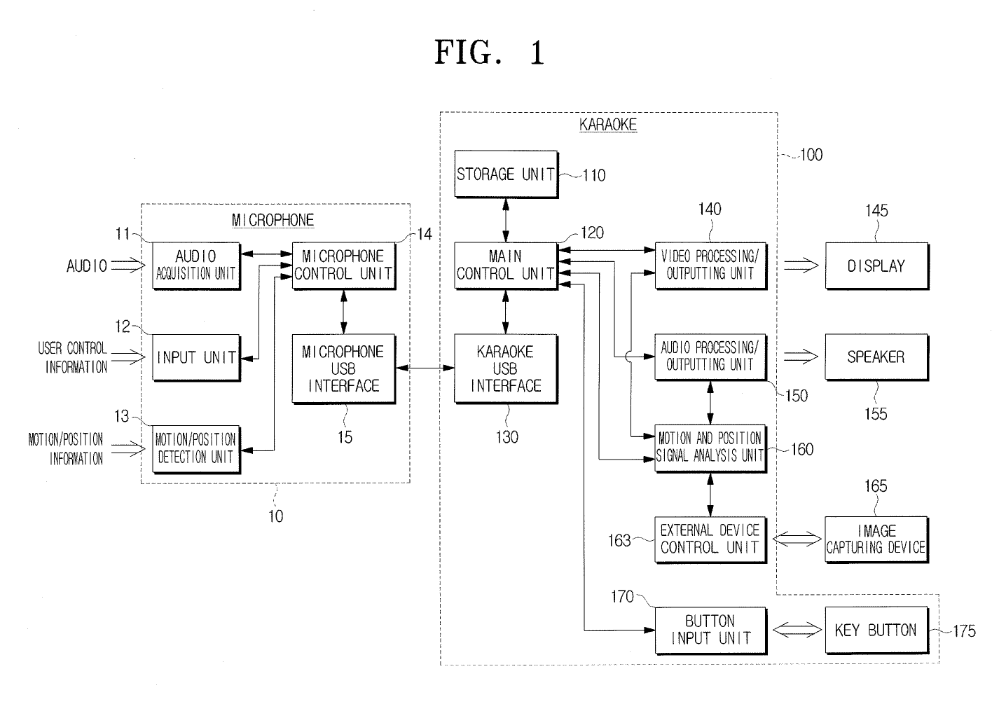

FIG. 1 is a block diagram illustrating a karaoke system according to an embodiment of the present general inventive concept. As illustrated in FIG. 1, the karaoke system may include a microphone 10 and a karaoke apparatus 100 to provide accompaniment to a user as an amusement device.

The microphone 10 receives a voice from a user. In the embodiment of the present general inventive concept, the microphone 10 may receive information, such as control information, motion information, and/or position information. In addition, the karaoke apparatus 100 processes the information received through the microphone 10, and operates one or more devices required to play the accompaniment.

The microphone 10 may include an audio acquisition unit 11, an input unit 12, a motion/position detection unit 13, a microphone control unit 14, and an interface, such as a microphone Universal Serial Bus (USB) interface 15.

The audio acquisition unit 11 receives sound waves of a user's voice and converts the received sound waves into an audio signal, such as an analog audio signal. In addition, in order to use a microphone USB interface 15 to be described later, the audio acquisition unit 11 converts the input analog audio signal into a digital audio signal transmittable through the microphone USB interface 15. The audio acquisition unit 11 transmits the converted digital audio signal to the microphone control unit 14.

The input unit 12 receives user's control information. Here, the control information may include information about functions required for the user to use the karaoke apparatus 100, such as a music selection signal (or a music selection number) to select a song, tone adjustment, tempo adjustment, and the like.

Accordingly, the input unit 12 may be provided with diverse key buttons. For example, the input unit 12 may include numeral buttons for music selection, a tone adjustment button, a tempo adjustment button, and the like. The user can control the karaoke apparatus 100 by pushing the key buttons provided in the input unit 11.

The motion/position detection unit 13 detects at least one of motion information and position information. The motion information and the position information may be information on a motion (movement) and a position of the user, the audio input device 10, or the audio acquisition unit 11, with respect to a reference movement or a reference position, which may be a location of the karaoke apparatus 100. The motion/position detection unit 13 may include at least one motion detection sensor and/or at least one position detection sensor.

The motion detection sensor may be implemented by a gyro sensor. The gyro sensor is a sensor to detect a motion (movement) of an object using the gyroscope principle. Accordingly, if the motion detection sensor is provided in the motion/position detection unit 13, the user's motion can be detected through the motion of the microphone 10.

In addition, the motion detection sensor may be implemented by other sensors except for the gyro sensor. For example, a tilt sensor may be used as the motion detection sensor. The tilt sensor senses the tilt of the microphone 10, and if the tilt is changed, it is judged that the motion is detected. In addition, the user's motion can also be detected using a geomagnetic sensor, an acceleration sensor, an altimeter, and the like.

It is possible that the position detection sensor may be implemented by a gyro sensor. The motion/position detection unit 13 can detect a present position by receiving an input of position change information from the gyro sensor after a user's initial position is set. That is, coordinate values of the present position can be calculated by adding position change coordinate values to coordinate values of the initial position.

Also, the position detection sensor may be implemented by other sensors except for the gyro sensor. For example, four or more distance sensors may be installed in a room where the karaoke apparatus 100 is located, and the position of the microphone 10 or the user with respect to a reference position, for example, the karaoke apparatus 100, be detected using the distance sensors. In addition, the position detection sensor may be implemented using an infrared sensor, an ultrasonic sensor, and the like.

The microphone control unit 14 controls the operation of the audio acquisition unit 11, the input unit 12, the motion/position detection unit 13, and the microphone USB interface 15. In addition, the microphone control unit 14 converts the information inputted to the audio acquisition unit 11, the input unit 12, and the motion/position detection unit 13 into a signal form that can be transmitted to the USB interface 115.

The microphone USB interface 15 may be implemented to transmit the audio signal using an audio class in the standard of the USB Forum. Also, the microphone USB interface 15 may be implemented to transmit a control signal using a Human Interface Devices (HID) class in the standard of the USB Forum. As described above, by transmitting the audio signal using the standard of the USB Forum, the compatibility between the microphone 10 and the karaoke apparatus 100 can be secured.

However, the microphone USB interface 15 does not necessarily use the standard of the USB Forum, but can transmit signals using other methods. For example, the signal may be transmitted using the standard directly defined by a manufacturer of the karaoke apparatus 100.

The karaoke apparatus 100 may include a storage unit 110, a main control unit 120, a karaoke USB interface 130, a video processing/outputting unit 140, a display 145, an audio processing/outputting unit 150, a speaker 155, a motion and position signal analysis unit 160, an external device control unit 163, an image capturing device 165, a button input unit 170, and a key button 175.

The storage unit 110 stores information and data required to operate the karaoke apparatus 100. For example, the storage unit 110 stores audio data for selectable music and sound effects, and video data to be displayed when the selected music is played. Also, the storage unit 110 stores a karaoke operating system. In addition, the storage unit 110 can store data of the present position information and motion information.

The main control unit 120 controls the operation of the karaoke apparatus 100. More specifically, the main control unit 120 judges signals received from the karaoke USB interface 130, and transfers control signals to corresponding devices. Also, the main control unit 120 controls the corresponding device to operate according to the received signals.

For example, when the user selects a song, the main control unit 120 receives a selection control signal, for example, the music selection signal, from the microphone 10 through the karaoke USB interface 130. Then, the main control unit 120 reads out audio data and video data of the selected song from the storage unit 110. Thereafter, the main control unit 120 transmits the read video data to the video processing/outputting unit 140, and controls the video processing/outputting unit 150 to display the read video data on the display 145. In addition, the main control unit 120 transmits the read audio data to the audio processing/outputting unit 140, and controls the audio processing/outputting unit 140 to output the read audio data through the speaker 155.

The karaoke USB interface 130 receives the audio signal, control information, motion information and position information from the microphone 10. The karaoke USB interface 130 may also receive other sensor input information.

The karaoke USB interface 130 may be implemented to receive the audio signal using the audio class in the standard of the USB Forum. Also, the karaoke USB interface 130 may be implemented to receive the control signal using the Human Interface Devices (HID) class in the standard of the USB Forum. By receiving the audio signal and the control signal using the standard of the USB Forum as described above, the compatibility between the microphone 10 and the karaoke apparatus 100 can be secured.

However, the karaoke USB interface 130 does not necessarily use the standard of the USB Forum, but can receive signals using other methods. For example, the signal may be received using the standard directly defined by a manufacturer of the karaoke.

The video processing/outputting unit 140 processes and outputs the video data read from the storage unit 110. Specifically, the video processing/outputting unit 140 receives the video data selected through the main control unit 120, and generates a video signal to be displayed on the display 145.

The display 145 displays the video signal received from the video processing/outputting unit 140 on a screen thereof. In addition to the video data stored in the storage unit 110, a broadcasting video signal received through an antenna (not illustrated) may be displayed on the screen of the display 145. The karaoke apparatus 100 may receive the broadcasting video signal and may transmit the broadcasting video signal to the display 145 to be displayed thereon.

The audio processing/outputting unit 150 processes and outputs audio data read from the storage unit 110. Specifically, the audio processing/outputting unit 150 receives the audio data selected through the main control unit 120, and generates an audio signal to be outputted through the speaker 155. The audio data may include not only the accompaniment of the selected song but also the sound effect selected by the user.

In addition, the audio processing/outputting unit 150 processes and outputs the audio data of the user's voice inputted through the microphone 10.

The speaker 155 produces sound by outputting the audio signal received from the audio processing/outputting unit 150. That is, the speaker 155 outputs the accompaniment of the selected song, the sound effect, and the user's voice.

The motion and position signal analysis unit 160 judges the user's motion or position by analyzing the motion information and position information inputted through the microphone 10. Then, the motion and position signal analysis unit 160 controls the corresponding devices according to the user's motion or position.

For example, if motion information is received from the microphone 10 through the karaoke USB interface 130, the motion and position signal analysis unit 160 controls the audio processing/outputting unit 150 to output a sound effect corresponding to the motion information. Here, the sound effect may be a tambourine sound or beat box. The sound effect may be preset according to a type of the motion and/or position information.

In addition, if a position signal is received from the microphone 10 through the karaoke USB interface 130, the motion and position signal analysis unit 160 controls the image capturing device 165 so that the operation of the image capturing device 165 is changed according to the position information. More specifically, if the position signal is received, the motion and position signal analysis unit 160 transfers the position signal to the external device control unit 163. The external device control unit 163 changes the angle of the image capturing device 145 so that a point where the position signal appears is captured. Through this, the image capturing device 145 can continuously capture the image of the user in motion or the image of the user holding the microphone 10.

In addition, the motion and position signal analysis unit 160 may control the video processing/outputting unit 140 to display the image that is being captured by the image capturing device 165 on the display 145.

The display 145 may selectively or simultaneously display the video signal of the storage unit 110 and the image of the image capturing device 165. The video signal of the storage unit 110 and the image of the image capturing device 165 can be simultaneously displayed on the display 145 using a picture-in-picture operation according to a selection of the input unit 12 or the button input unit 170.

The button input unit 170 receives the control information through the user's manipulation of the key button 175, and controls the karaoke apparatus 100 to operate according to the input control information.

The operation of the karaoke apparatus 100 can be controlled by the control information of the input unit 12, a control signal of the button input unit 17, and/or the motion and/or position information of the motion/position detection unit 13.

The microphone 10 may have a combination of the audio acquisition unit 11, the input unit 12, and the motion/position detection unit 13 in a single body, and may transmit one or more signals output from the combination of the audio acquisition unit 11, the input unit 12, and the motion/position detection unit 13, to the karaoke apparatus 100.

From the foregoing, the function and effect of the microphone 10 and the karaoke apparatus 100 have been described in detail with reference to FIG. 1.

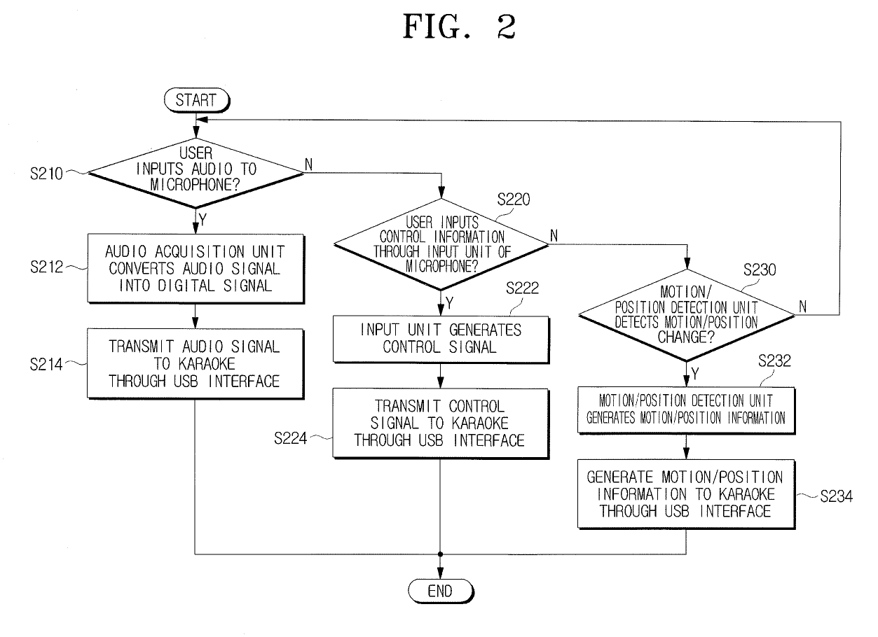

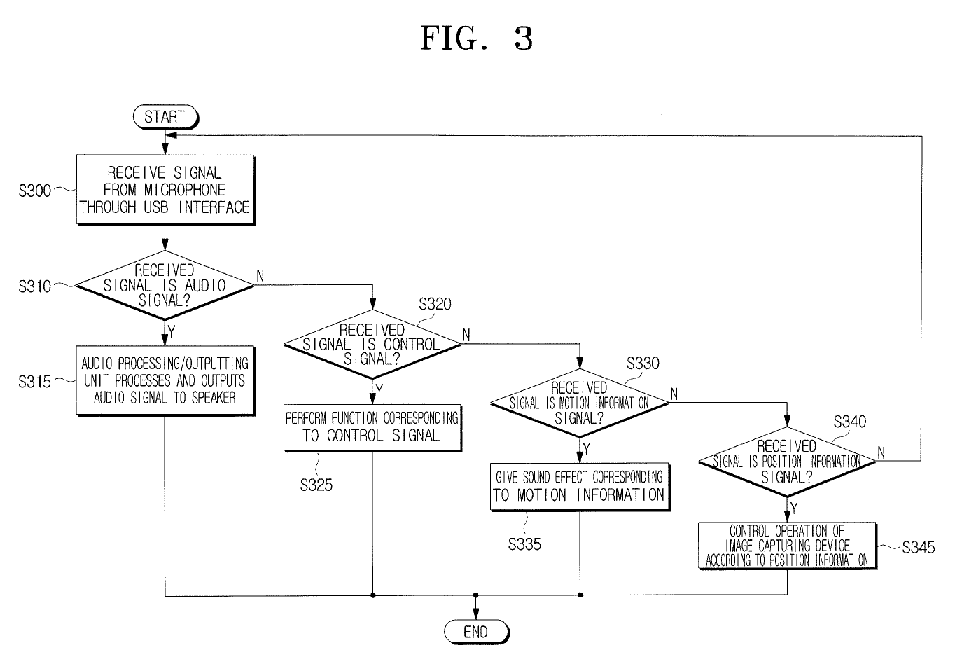

Hereinafter, the operation of the microphone 10 and the karaoke apparatus 100 will be described in detail with reference to FIGS. 2 and 3.

FIG. 2 is a flowchart illustrating an accompaniment method of a microphone 0 according to an embodiment of the present general inventive concept.

Referring to FIGS. 1 and 2, the microphone 10 judges (determines) whether a user has inputted a voice at operation S210. If the user has inputted the voice (“Y” at operation S210), the audio acquisition unit 11 receives sound waves of the user's voice and converts the received sound waves into an analog audio signal. In addition, the audio acquisition unit 11 converts the input analog audio signal into a digital audio signal at operation S212. The microphone control unit 14 controls the audio signal to be transmitted to the karaoke 100 through the USB interface 15 at operation S214.

If the user has inputted control information through the input unit 12 (“Y” at operation S220), the input unit 12 generates a control signal for the control information inputted by the user at operation S222. Then, the microphone control unit 14 controls the control signal to be transmitted to the karaoke 100 through the USB interface 15 at operation S224.

In addition, if the motion/position detection unit 13 of the microphone 10 has detected the change of the user's motion or position (“Y” at operation S230), the motion/position detection unit 13 generates the motion information or the position information at operation S232. Then, the microphone control unit 14 controls the motion information or the position information to be transmitted to the karaoke 100 through the USB interface 15 at operation S234.

Through the above-described process, the microphone 10 transmits the audio signal, control signal, motion information, and position information using the microphone USB interface 15.

FIG. 3 is a flowchart illustrating an accompaniment method of a karaoke apparatus according to an embodiment of the present general inventive concept.

Referring to FIGS. 1 and 3, the karaoke apparatus 100 receives the signal from the microphone 10 through the karaoke USB interface 130 at operation S300. If the receive signal is the audio signal (“Y” at operation S310), the audio processing/outputting unit 150 processes and outputs the audio signal to the speaker 155 at operation S315. That is, the audio processing/outputting unit 150 makes the user's voice be outputted through the speaker 155.

By contrast, if the received signal is the control signal (“Y” at operation S320, the main control unit 120 controls the karaoke 100 to perform a function corresponding to the control signal at operation S325.

For example, if the user has selected a song, the main control unit 120 receives the selection control signal from the microphone 10 through the karaoke USB interface 130. The main control unit 120 then reads out the audio data and video data of the selected song from the storage unit 110. Then, the main control unit 120 transmits the read video data to the video processing/outputting unit 140, and controls the video processing/outputting unit 140 to display the read video data on the display 145. In addition, the main control unit 120 transmits the read audio data to the audio processing/outputting unit 140, and controls the audio processing/outputting unit 140 to output the read audio data through the speaker 155.

If the received signal is the motion information signal (“Y” at operation S330, the motion and position signal analysis unit 160 analyzes the kind of motion information. The audio processing/outputting unit 150 gives the sound effect according to the kind of motion information at operation S335.

For example, if the user shakes the microphone 10 left and right, the audio processing/outputting unit 150 may provide a sound effect that the tambourine sound is outputted from the speaker 155. In addition, if the user shakes the microphone 10 up and down, the audio processing/outputting unit 150 may provide a sound effect that a beat box is outputted from the speaker 155.

On the other hand, if the received signal is the position information signal (“Y” at operation S340), the motion and position signal analysis unit 160 finds out the user's position by analyzing the position information. The external device control unit 163 controls the operation of the image capturing device 165 according to the position information at operation S345.

For example, if the position signal is received, the motion and position signal analysis unit 160 transfers the position signal to the external device control unit 163. The external device control unit 163 changes the angle of the image capturing device 145 so that the point where the position signal appears is captured. Through this, the image capturing device 145 can continuously capture the image of the user in motion.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

From the foregoing, the operation of the microphone 10 and the karaoke 100 has been described in detail with reference to FIGS. 2 and 3.

In the embodiment of the present general inventive concept, it is exemplified that the microphone 10 and the karaoke apparatus 100 transmit and/or receive information through the USB interface. However, the information can also be transmitted or received by other methods than the USB interface. For example, the signal can be transmitted using methods of wireless USB, Bluetooth, Wifi, and the like

According to the present general inventive concept, an audio input device and a karaoke apparatus to detect user's motion and position information, and an accompaniment method adopting the same are provided, and a user can conveniently use the karaoke through a microphone having diverse functions.

In particular, by transmitting information between the microphone and the karaoke apparatus using the USB interface, diverse information such as sensor input information and so on can be transmitted. Through this, the user can use additional function using the motion information and position information.

In addition, by using the standard of the USB interface, the compatibility of the karaoke can be heightened.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An audio input device comprising:
an audio acquisition unit to receive an input of an audio from a user;
a detection unit to detect at least one of user's motion information and position information; and
an interface to transmit an audio signal inputted through the audio acquisition unit and at least one of the motion information and the position information detected by the detection unit to an external device.

2. The audio input device of claim 1, wherein the interface comprises a USB (Universal Serial Bus) interface.

3. The audio input device of claim 1, wherein the detection unit comprises at least one motion detection sensor or at least one position detection sensor.

4. The audio input device of claim 3, wherein the motion detection sensor comprises a gyro sensor.

5. The audio input device of claim 3, wherein the position detection sensor comprises a gyro sensor, and the detection unit detects a present position by receiving an input of a position change from the gyro sensor after an initial position is set.

6. The audio input device of claim 1, further comprising:
an input unit to receive control information from the user
wherein the interface transmits the control information together with at least one of the audio signal and the at least one of the motion information and the position information.

7. An accompaniment method of an audio input device, the method comprising:
receiving an input of an audio from a user;
detecting at least one of user's motion information and position information; and
transmitting an input audio signal and at least one of the detected motion information and position information to an external device.

8. The accompaniment method of claim 7, wherein the transmitting operation comprises transmitting the input signal and information through a USB (Universal Serial Bus) interface.

9. A karaoke apparatus comprising:
an interface to receive at least one of an audio signal, motion information, and position information from a first external device;
an audio processing/outputting unit to process and output the audio signal to a speaker so that sound is produced from the speaker; and
a control unit to control an operation of a second external device using the at least one of the motion information and the position information.

10. The karaoke of claim 9, wherein the interface comprises a USB (Universal Serial Bus) interface.

11. The karaoke of claim 9, wherein the control unit controls an audio output to give a sound effect according to the motion information when the motion information is received through the interface.

12. The karaoke of claim 9, wherein the control unit controls an image capturing device connected to the karaoke so that an operation of the image capturing device is changed according to the position information if the position information is received through the interface.

13. An accompaniment method of a karaoke apparatus, the method comprising:
receiving at least one of an audio signal, motion information, and position information from a first external device;
processing and outputting the audio signal to a speaker; and
controlling an operation of a second external device using at least one of the motion information and the position information.

14. The accompaniment method of claim 13, wherein the receiving operation comprises receiving the signal and information through a USB (Universal Serial Bus) interface.

15. The accompaniment method of claim 13, further comprising:
controlling an audio output to give a sound effect according to the motion information when the motion information is received.

16. The accompaniment method of claim 13, further comprising:
controlling an image capturing device so that an operation of the image capturing device is changed according to the position information if the position information is received.

17. An audio input device comprising:
an input unit to receive an input of control information from a user; and
an interface to transmit an audio signal and the input control information to an external device through serial communications.

18. The audio input device of claim 17, wherein the interface comprises a USB (Universal Serial Bus) interface.

19. A karaoke apparatus comprising:
an interface for receiving at least one of an audio signal and control information from a first external device through serial communications; and
a control unit for controlling an operation of a second external device using the control information.

20. The karaoke of claim 19, wherein the interface comprises a USB (Universal Serial Bus) interface.

21. An audio input device comprising:
an audio acquisition unit to receive an input of an audio from a user;
a detection unit to detect at least one of user's motion information and position information;
an input unit to receive an input of control information from a user; and
an interface to transmit an audio signal inputted through the audio acquisition unit, at least one of the motion information and the position information detected by the detection unit to an external device, and the input control information.

22. A karaoke apparatus comprising:
an interface to receive a combination of at least two of an audio signal, at least one of motion information and position information, and control information from an external device;
an audio processing/outputting unit to process and output the audio signal to a speaker so that sound is produced from the speaker; and
a control unit to control at least two devices according to the combination.

23. A karaoke system comprising:
an audio input device to receive an input of an audio from a user, to detect at least one of user's motion information and position information, to receive an input of control information from a user, and to transmit a combination of an audio signal inputted through the audio acquisition unit, at least one of the motion information and the position information detected by the detection unit to an external device, and the input control information; and
a karaoke apparatus connectable to the audio input device to receive the combination, to control a speaker and another device according to the combination.

24. A karaoke system comprising:
an audio input device to transmit a combination of at least two of an input of a sound of a user, control information, and at least one of motion and position information; and
a karaoke apparatus connectable to the audio input device to receive the combination from the audio input device, and to control at least two devices according to the received combination.

25. An audio input device comprising:
an audio acquisition unit to receive an input of an audio from a user;
a unit to generate at least one of control information and one of motion information and position information; and
an interface to output the audio input and the at least one of the control information and the motion information.

26. A karaoke apparatus comprising:
an interface to receive an audio input and at least one of control information and one of motion information and position information; and
a control unit to control at least two devices according to the audio input and the at least one of the control information and the one of the motion information and position information.

27. A method of a karaoke system, the method comprising:
receiving an input of an audio from a user, detecting at least one of user's motion information and position information, receiving an input of control information from a user, and transmitting a combination of an audio signal inputted through the audio acquisition unit, at least one of the motion information and the position information detected by the detection unit to an external device, and the input control information; and
receiving the transmitted combination, and controlling a speaker and another device according to the combination.

28. A method of a karaoke system, the method comprising:
transmitting a combination of at least two of an input of a sound of a user, control information, and at least one of motion and position information; and
receiving the combination from the audio input device, and controlling at least two devices according to the received combination.
